(19) United States
(12) Patent Application Publication
(10) Pub. No.: US 2021/0131841 A1
(43) Pub. Date: May 6, 2021

(54) SENSOR ELEMENT FOR DETECTING AT LEAST ONE PROPERTY OF A FLUID MEDIUM

(71) Applicant: Robert Bosch GmbH, Stuttgart (DE)

(72) Inventors: Gerhard Hueftle, Aspach (DE); Benjamin Plogmann, Rosswaelden (DE); Uwe Konzelmann, Asperg (DE)

(21) Appl. No.: 16/499,958

(22) PCT Filed: Mar. 15, 2018
(86) PCT No.: PCT/EP2018/056572

§ 371 Date: Oct. 1, 2019

(30) Foreign Application Priority Data
Apr. 5, 2017 (DE) 10 2017 205 838.2

(51) Int. Cl. G01F 1/40; G01L 19/14

(52) U.S. Cl. CPC G01F 1/40; G01L 19/147

(57) ABSTRACT

A sensor element is provided for detecting at least one property of a fluid medium. The sensor element includes at least one housing. The housing forms at least one flow channel through which the fluid medium is able to flow. A pressure tap branches off from the flow channel, in which at least one pressure sensor for detecting a pressure of the fluid medium is situated. At least one cavity is situated between the flow channel and the pressure sensor for collecting contaminants in at least one wall of the pressure tap.

### BACKGROUND INFORMATION

Various kinds of sensor elements for detecting at least one property of a fluid medium are available in the related art. Without limitation of further possible restrictions, the present invention is described below with reference to pressure-based air mass meters. However, other embodiments are also possible.

For example, the air mass in air systems such as for example in the induction tract of an internal combustion engine may be determined using various measuring principles. Besides thermal measuring principles, for example in the form of hot-film air mass meters (HFM), pressure-based air mass measurements are also used, which are based on at least one pressure measurement. In this regard, the so-called Prandtl probes or Venturi tubes should be mentioned, for example. For example, for determining an air mass, which flows per unit of time through a tube, it is possible to measure a differential pressure from two static pressures or from a static pressure and an absolute pressure. It is possible to improve the accuracy of the air mass measurement in these methods for example by determining the density using additional pressure and/or temperature measurements.

German Patent Application No. DE 10 2014 212 854 A1, for example, describes a flow rate meter for measuring a flow rate of a fluid medium flowing through a flow tube in a main flow direction. The flow rate meter comprises an impeding element, which partially narrows a flow cross section of the flow tube. The flow rate meter furthermore comprises a first pressure measuring point, which is situated upstream from the impeding element with respect to the main direction of flow, and a second pressure measuring point, which is situated downstream from the impeding element with respect to the main direction of flow. The impeding element is designed to narrow the flow cross section in a variable manner.

German Patent Application No. DE 10 2007 053 273 A1 describes a flow rate meter for measuring a flow rate of a fluid medium flowing through a flow tube in a main flow direction. The flow rate meter has a plug segment having an inflow side and an outflow side. In the plug segment, an accumulation chamber is formed on the inflow side that is accessible from the inflow side through an opening. A first pressure measuring point is accommodated in a lateral wall of the accumulation chamber. A second pressure measuring point is accommodated in an outer wall of the plug segment.

In spite of the advantages achieved by conventional measuring devices, a multitude of technical challenges remain in the measurement of flow properties of fluid media. Particularly in the induction tract of internal combustion engines, it is a challenge for example to protect the sensors used against water and dirt particles and thus to avoid a false indication of the pressure sensors and an associated false indication of the air mass.

### SUMMARY

In accordance with an example embodiment of the present invention, a sensor element is provided for detecting at least one property of a fluid medium. As described in more detail below, the sensor element may be embodied for example as an air mass meter, a flow rate meter, a current meter, an absolute pressure meter or a differential pressure meter. For example, the present invention may be used in one or more of the above-mentioned flow rate meters. However, other embodiments are fundamentally also possible.

The at least one property of the fluid medium may be in particular a flow property, for example a speed, a volume flow, a mass flow, a pressure, a pressure difference or another physically measurable property. However, other properties are fundamentally also possible. In particular, the sensor element may be designed to detect an absolute pressure and/or a differential pressure of the fluid medium.

The sensor element may be developed in particular entirely or partially as a plug sensor. Thus, the housing may for example form a plug sensor or comprise a plug sensor, which may be plugged into a flow tube of the fluid medium, for example into an induction tract of an internal combustion engine or may project into this flow tube. However, other embodiments are fundamentally also possible.

The fluid medium may fundamentally be any gas or any liquid. In particular, the fluid medium may be an intake air mass of an internal combustion engine or an exhaust gas of an internal combustion engine. Accordingly, the sensor element may be used in particular in the area of automotive technology. However, other areas of application are fundamentally also possible.

The sensor element comprises at least one housing having at least one flow channel through which fluid medium is able to flow. The flow channel may be designed for example as a closed flow tube. Alternatively, however, the flow channel may also be simply formed by a wall of the housing, over which the fluid medium is able to flow. The housing may be produced for example from a plastic, a ceramic material or also from a metallic material.

A pressure tap branches off from the flow channel, for example from a wall of the flow channel. A pressure tap is to be understood generally as a channel running crosswise with respect to the flow in the flow channel, into which the fluid medium flowing through the flow channel may be diverted. The pressure tap may be designed in particular as a blind channel, for example as a blind hole.

At least one pressure sensor for detecting a pressure of the fluid medium is situated in the pressure tap. As will be described in greater detail below, the pressure sensor may be in particular at least one micromechanical pressure sensor, for example at least one micromechanical pressure sensor element, for example a semiconductor sensor. Such sensors are normally based on an absolute pressure or a differential pressure deforming a diaphragm of the pressure sensor element, it being possible to measure the deformation of the diaphragm for example by piezo-sensors and/or by resistors.

At least one cavity is situated between the flow channel and the pressure sensor for collecting contaminants in at least one wall of the pressure tap. A cavity is in this case to be generally understood as a space that is open toward the pressure tap. The pressure tap may be designed to be essentially cylindrical, for example, the cavity having a hollow space outside of a cylinder volume of the cylindrical pressure tap. The cavity may for example comprise at least one cut-out, also called a recess, in at least one wall of the pressure tap. For example, it is possible for the cavity, as described in more detail below, to have an annular recess. The cavity is open in particular toward the pressure tap.

The pressure tap may have in particular a bore branching off from the flow channel. Thus, the pressure tap may have for example a cylindrical bore branching of from the flow channel, in particular from a wall of the flow channel, which may be designed for example as a round or also as a polygonal cylindrical bore. The pressure tap may be designed in particular as a blind-end bore branching off from the flow channel, it being possible for the pressure sensor to be situated preferably at one end of the blind-end bore, that is, on an end face of the blind hole. The pressure tap may be designed for example entirely or partially as a cylindrical bore, one end of the cylindrical bore being open toward the flow channel, whereas the other end of the cylindrical bore is closed entirely or partially by the pressure sensor, and the at least one recess for example being situated for example in a wall, for example a cylindrical wall, of the bore. The recess may be situated for example in radial symmetry around an axis of the cylindrical bore, for example in annular fashion. The recess may be designed as an annular groove for example. Thus, the cavity may be designed for example generally as a recess in a wall of the bore, in particular as a groove, for example as an annular and in particular as a circular ring-shaped groove, which may be situated in particular in axial symmetric fashion with respect to an axis of the bore.

The annular recess may have in particular a diameter or equivalent diameter, which amounts for example to at least 1.2 times a diameter or equivalent diameter of the bore, preferably 1.5 times and particularly 1.5 to 2.5 times the diameter or equivalent diameter of the bore.

Furthermore, the recess may have a height along an axis of the bore. This height may be 3 to 6 mm, for example.

The recess may have in particular an undercut. An undercut is in this case to be generally understood as a cavity that has a sharp edge so that, when viewed from the flow tube, a portion of the cavity is covered by the sharp edge and is not visible. Thus, the recess may have at least one edge at the transition to the wall of the bore, for example an annular circumferential edge, preferably an edge having an angle of essentially 90°.

Furthermore, between the recess and the pressure sensor, in particular at least one wall section of the wall of the bore may be situated that has no recess. Thus, it is possible for the at least one cavity to be situated in particular at a distance from the pressure sensor.

In particular, the pressure tap may branch off from the flow channel essentially perpendicularly. In this connection as well as previously, “essentially perpendicularly” or “at an angle of essentially 90°” means an angle of 90°, deviations of ±15°, preferably no more than ±10° and particularly preferably no more than ±5° being tolerable, however.

The example sensor element according to the present invention may have numerous advantages over conventional sensor elements.

In particular, the cavity is able to collect contaminants such as water and dirt particles. It is possible, for example, for water and dirt particles to enter the pressure tap, which may, for example due to the flow and/or a surface tension, creep along a wall of the pressure tap and thus enter the cavity. In this manner, it is possible to protect the pressure sensor against water and dirt particles in that these are stored in the cavity. The pressure tap may be accordingly designed in such a way that water and dirt particles for example cannot reach the sensor element and that thus for example only dry air reaches the pressure sensor. One advantage of this design is that it makes it possible to avoid fundamentally a temporary false indication of pressure sensors due to water and dirt deposition. Furthermore, it is possible to avoid at least largely a permanent change in the characteristic curve of pressure sensors and thus a faulty determination of the air mass due to dirt depositions, in particular after the water has evaporated.

### BRIEF DESCRIPTION OF THE DRAWINGS

Additional details and optional features of the present invention are presented in the exemplary embodiments, which are shown schematically in the figures.

FIG. 1 shows an exemplary embodiment of a sensor element according to the present invention.

FIGS. 2A and 2B show different illustrations of a sensor element according to the present invention in the form of a plug sensor.

FIG. 3 shows an induction tract of an internal combustion engine in which the sensor element of the present invention is situated between an intercooler and a throttle valve.

### DETAILED DESCRIPTION OF EXAMPLE EMBODIMENTS

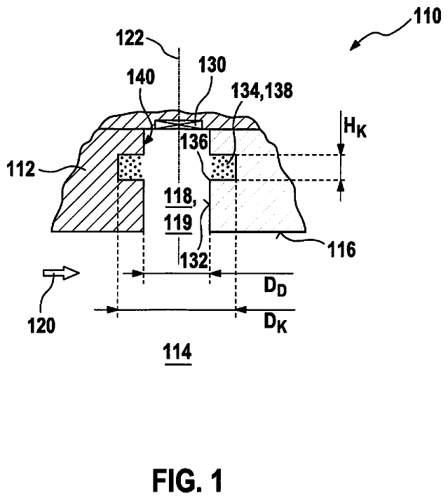

FIG. 1 shows an exemplary embodiment of a sensor element 110 according to the present invention in a schematic sectional view. Sensor element 110 comprises a housing 112, which may be designed in one piece or in multiple pieces. Housing 112 forms at least one flow channel 114 through which the fluid medium is able to flow. Within the scope of the present invention there exist multiple possibilities as to how this housing 112 forms the flow channel 114. Thus flow channel 114 may be fully enclosed by housing 112 for example so that flow channel 114 is situated entirely in housing 112, for example. Alternatively or additionally, however, housing 112 may merely have or form at least one flow channel wall 116, across which the fluid medium is able to flow. Flow channel 114 may accordingly be designed as a flow tube for example or for example as an open space, which is formed at least on one side by flow channel wall 116.

At least one pressure tap 118 is formed in flow channel wall 116. Pressure tap 118 may be designed in particular entirely or partially as a bore 119. This pressure tap 118 branches off from the flow channel. For this purpose, pressure tap 118 may have for example, as shown in FIG. 1, a bore, which branches off from flow channel 114 preferably at a right angle with respect to flow channel wall 116. For example, it is possible for flow channel 114 to be designed in such a way that the fluid medium is able to flow through it in a main flow direction 120, which may be formed parallel to flow channel wall 116, for example. Pressure tap 118 and/or an axis 122 of pressure tap 118, for example a cylinder axis, may run for example generally perpendicularly with respect to this main flow direction 120. However, other embodiments are fundamentally also possible.

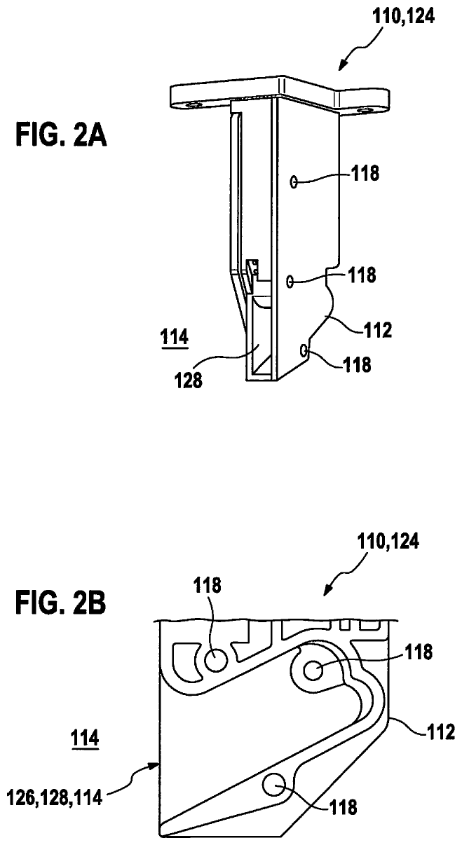

FIGS. 2A and 2B illustrate how housing 112 and pressure tap 118 may be designed. These figures thus show different illustrations of a sensor element 110 according to the present invention, which in the exemplary embodiments shown is designed as a plug sensor 124. Plug sensor 124 may project into flow channel 114 for example so that a flow channel wall 116 is partially formed by housing 112 of the plug sensor. FIG. 2A shows an embodiment of plug sensor 124 having a closed cover, whereas in the embodiment shown in FIG. 2B a cover is removed so that a channel section 126 situated in housing 112 is visible, into which fluid medium is able to enter through an opening 128. For possible embodiments of sensor element 110, it is possible to refer to the above-cited document DE 10 2007 053 273 A1, by way of example. However, other embodiments are fundamentally also possible. As may be seen in these figures, sensor element 110 may have multiple pressure taps 118, which may be situated within channel section 126 and/or on an outer side of plug sensor 124. Thus, any area of housing 112, which is reachable by the fluid medium and over which the fluid medium is able to flow, may act as a flow channel wall 116, which has at least one pressure tap 118. For example, in the example shown, two pressure taps may be situated on an outer side of housing 112, that is, on an outer side of plug sensor 124, and one pressure tap 118 may be situated in the interior of channel section 126. Various embodiments are possible.

As may be further seen in FIG. 1, at least one pressure sensor 130 is situated in pressure tap 118. For example, pressure tap 118 may be designed essentially cylindrically around axis 122, and pressure sensor 130 may be situated for example at one end of cylindrically designed pressure tap 118. For example, pressure tap 118 may be designed accordingly as a blind hole, having a side that is open toward flow channel 114 and a end face facing away from this open side, which is closed and on which pressure sensor 130 is situated.

Pressure tap 118 furthermore comprises a wall 132, which may be designed as cylinder wall 132 for example. This wall 132 may be designed for example in a circular-cylindrical manner. A polygonal cross section is fundamentally also possible however. In the exemplary embodiment shown, a cavity 134 is situated in this wall 132. This cavity 134, preferably has at least one sharp edge 136 so that cavity 134 preferably forms an undercut in cylindrical pressure tap 118. Cavity 134 may be accordingly developed for example as recess 138, for example as an annular groove, for example as a cylindrical annular groove. Cavity 134 may be for example axially symmetrical with respect to axis 122 and may have for example a diameter or equivalent diameter D_{K}, whereas the cylindrical bore of the pressure tap 118 itself may have for example a diameter or equivalent diameter D_{D}. Furthermore, along axis 122, cavity 134 may have for example a height, for example a cylinder height, H_{K}. Between recess 138 and pressure sensor 130 and/or the end face of pressure tap 118, a wall section 140 may be situated for example, which is developed without recess and without cavity 134. Accordingly, cavity 134 may be developed for example at a distance from pressure sensor 130.

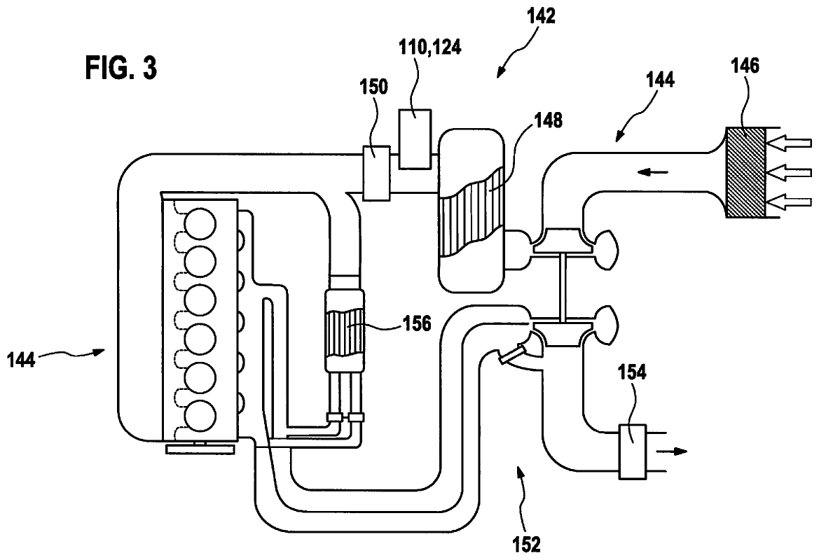

Sensor element 110, for example the sensor element 110 developed as plug sensor 124 as shown in FIGS. 2A and 2B, may be situated in an air system 142 of an internal combustion engine 144 for example, which is schematically shown in FIG. 3. As may be seen in FIG. 3, this air system 142 comprises an induction tract 144 having an air filter 146, an intercooler 148 and a throttle valve 150 as well as an exhaust tract 152 having an exhaust flap 154. Furthermore, optionally, an exhaust-gas recirculation system 156 may be provided. Sensor element 110 may be situated for example between intercooler 148 and throttle valve 150 and may be designed for example as a pressure-based air mass meter.

In the system shown, water and dirt particles are able to advance with the flow to pressure taps 118 of sensor element 110. Cavity 134 as shown in FIG. 1 is provided in order to protect the at least one pressure sensor 130, which is able to act as an absolute pressure sensor and/or as a differential pressure sensor, against water and/or dirt deposits. This may be developed as an undercut and may in this way be integrated into the pressure tap, whereby cavity 134 is formed. Drops of water that penetrate pressure tap 118 and run down wall 132 toward pressure sensor 130 are diverted by the undercut into cavity 134. Due to adhesion forces, the water remains in cavity 134 and does not advance to pressure sensor 130, as a result of which pressure sensor 130 remains protected against water and dirt particles until cavity 134 is completely filled. So that the water remains by adhesion in the cavity, the cavity height H_{K} should not exceed 4 to 6 mm. Thus, generally, in this exemplary embodiment or also in other exemplary embodiments, cavity 134 may have a height H_{K}, which preferably does not exceed 4 to 6 mm.

The protection against water may be increased by a greater cavity diameter D_{K}. Alternatively or additionally, the cavity cross section A_{K} may be improved while maintaining a maximum cavity height H_{K}.

Furthermore, in this or also in other exemplary embodiments of sensor element 110, multiple cavities may be provided instead of a single cavity 134. Thus, for example, multiple recesses 134 may be provided, for example in the form of multiple sequentially arranged annular grooves, which are arranged along axis 118 in wall 132.

1-11. (canceled)

12. A sensor element for detecting at least one property of a fluid medium, comprising:
at least one housing, the housing forming at least one flow channel through which the fluid medium is able to flow, a pressure tap branching off from the flow channel; and
at least one pressure sensor being situated in the pressure tap configured to detect a pressure of the fluid medium;
wherein at least one cavity is situated between the flow channel and the pressure sensor for collecting contaminants in at least one wall of the pressure tap.

13. The sensor element as recited in claim 12, wherein the sensor element is one of the following: an air mass meter, or a flow rate meter, or a current meter, or an absolute pressure meter, or a differential pressure meter.

14. The sensor element as recited in claim 12, wherein the pressure tap has a bore branching off from the flow channel.

15. The sensor element as recited in claim 14, wherein the bore is entirely or partially a cylindrical bore.

16. The sensor element as recited in claim 14, wherein the pressure tap is a blind-end bore branching off from the flow channel, the pressure sensor being situated on one end of the blind-end bore.

17. The sensor element as recited in claim 14, wherein the cavity is a recess in a wall of the bore).

18. The sensor element as recited in claim 14, wherein the recess has an annular shape.

19. The sensor element as recited in claim 18, wherein the recess having the annular shape has a diameter or equivalent diameter, which is at least 1.2 times the diameter or equivalent diameter of the bore.

20. The sensor element as recited in claim 17, wherein the recess has an undercut.

21. The sensor element as recited in claim 17, wherein the recess has at least one edge at a transition to the wall of the bore.

22. The sensor element as recited in claim 17, wherein between the recess and the pressure sensor, at least one wall section of the wall of the bore is situated, which has no recess.
